(19) United States
(12) Patent Application Publication
(10) Pub. No.: US 2003/0124221 A1
(43) Pub. Date: Jul. 3, 2003

(54) Method and apparatus for grinding, blending, and proportioning meat, and apparatus calibration

(76) Inventor: Anthony J.M. Garwood, Mercer Island, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 10/368,679

(22) Filed: Feb. 14, 2003

Related U.S. Application Data
(63) Continuation-in-part of application No. 10/320,863, filed on Dec. 16, 2002.
(63) Continuation-in-part of application No. 10/027,929, filed on Dec. 20, 2001.
(63) Continuation-in-part of application No. 10/037,440, filed on Jan. 2, 2002.
(63) Continuation-in-part of application No. PCT/US01/45146, filed on Nov. 28, 2001.
(63) Continuation-in-part of application No. 09/724,287, filed on Nov. 28, 2000.
Application No. 09/724,287 is a continuation-in-part of application No. PCT/US00/29038, filed on Oct. 19, 2000.
Application No. PCT/US00/29038 is a continuation of application No. 09/550,399, filed on Apr. 14, 2000, now abandoned.
Application No. 09/550,399 is a continuation-in-part of application No. 09/392,074, filed on Sep. 8, 1999, now abandoned.
Application No. 09/392,074 is a continuation of application No. 09/039,150, filed on Mar. 13, 1998, now abandoned.
(60) Provisional application No. 60/040,556, filed on Mar. 13, 1997.

(51) Int. Cl. A23C 9/12

(52) U.S. Cl. 426/35

(57) ABSTRACT

The invention relates to a method of calibrating measuring devices used in the automated production of ground meat and apparatus for processing meat therewith.

### CROSS REFERENCES TO RELATED APPLICATIONS

This application is a continuation-in-part of applications Ser. Nos. 10/320,863, filed Dec. 16, 2002; 10/027,929, filed Dec. 20, 2001; 10/037,440, filed Jan. 2, 2002; PCT/US01/45146, filed Nov. 28, 2001; 09/724,287, filed Nov. 28, 2000, which in turn is a continuation-in-part of Application No. PCT/US00/29038, filed Oct. 19, 2000, now abandoned, which in turn is a continuation of U.S. application Ser. No. 09/550,399, filed Apr. 14, 2000, now abandoned, which in turn is a continuation-in-part of U.S. application Ser. No. 09/392,074, filed Sep. 8, 1999, now abandoned, which in turn is a continuation of U.S. application Ser. No. 09/039,150, filed Mar. 13, 1998, now abandoned, which in turn claims the benefit of U.S. Provisional Application No. 60/040,556, filed Mar. 13, 1997, and claims the benefit of U.S. Provisional Applications Nos. 60/129,595, filed Apr. 15, 1999; 60/141,569, filed Jun. 29, 1999; 60/144,400, filed Jul. 16, 1999; 60/148,227, filed Jul. 27, 1999; 60/149,938, filed Aug. 19, 1999; 60/152,677, filed Sep. 7, 1999; 60/154,068, filed Sep. 14, 1999; 60/160,445, filed Oct. 19, 1999; 60/175,372, filed Jan. 10, 2000; 60/255,684, filed Dec. 13, 2000; 60/286,688, filed Apr. 26, 2001; 60/291,872, filed May 17, 2001; 60/299,240, filed Jun. 18, 2001; 60/312,176, filed Aug. 13, 2001; 60/314,109, filed Aug. 21, 2001; 60/323,629, filed Sep. 19, 2001; 60/335,760, filed Oct. 19, 2001; 60/373,222, filed Apr. 15, 2002; 60/373,232, filed Apr. 16, 2002; 60/385,710, filed Jun. 3, 2002; 60/388,067, filed Jun. 10, 2002; 60/391,702, filed Jun. 24, 2002; 60/411,138, filed Sep. 16, 2002; 60/422,949, filed Oct. 30, 2002; 60/424,388, filed Nov. 5, 2002; 60/427,516, filed Nov. 19, 2002; 60/429,644, filed Nov. 25, 2002; 60/433,526, filed Dec. 13, 2002. All the above applications are herein expressly incorporated by reference in their entirety for all purposes.

### FIELD OF THE INVENTION

The invention relates to a method and apparatus for processing meat by providing at least two input streams of ground meat to a mixer, controlling the mass flow of each stream, measuring at least the fat content of each stream, and combining the streams into a single output stream and measuring the fat content of the combined stream; adjusting the mass flow of the input streams to produce blended ground meat with a selected proportion of fat, lean, and water. In particular, the present invention is directed to the detection of measurement readings that have drifted from actual and the manipulation of measurement readings to provide more accurate control of the controlled variable in meat, whether it is fat, lean, or water.

### BACKGROUND OF THE INVENTION

Disclosures in earlier applications of the present inventor have provided details of methods to produce ground meat product having selected fat, lean, and water ratios or percentages by providing at least two mass-flow controlled streams of meat that are then combined together to produce a single stream. The methods and apparatus use measuring devices that require periodic calibration. Such calibration has hitherto required an intervention procedure resulting in lost production time and the need to occasionally reprocess “out of specification” ground meat that has been produced with defective measuring devices that have not been correctly calibrated. Accordingly, there is a need to provide better measuring device calibration methods.

### SUMMARY OF THE INVENTION

The present invention provides an improved method of operation and an automated process to enable calibration of measuring devices used in the automatic production of ground meat.

According to one embodiment of the invention, a method of controlling the rate of a pump for an input stream to a mixer having a plurality of input streams being mixed into an output stream is provided. The method includes obtaining a plurality of composition measurements of an input meat stream being transferred by a pump. The method includes calculating a representative measurement based on the plurality of measurements. The method includes determining the flow rate capacity of the pump based on a controllable pump factor. The pump factor can include the speed. The method includes calculating the controllable pump factor that is calculated to give an input meat flow rate that will provide a meat product within a composition range and a flow rate range, wherein the meat product is comprised from at least two input meat streams of different compositions. The input meat flow rate is obtained by solving a mass balance equation around the mixer using the representative measurement to solve for the input meat flow rate.

According to another embodiment of the invention, a method of selecting one measurement reading from a pair of measurement readings, to use as a measured variable in the control of an input stream to a mixer having a plurality of input streams being mixed into an outlet stream, is provided. The method includes obtaining the composition measurement readings from input streams and the output stream around the mixer. The method includes calculating obtaining the flow rates of input streams and the output stream around the mixer. The method includes calculating a predicted input stream composition by solving a mass balance equation around the mixer using the flow rates and the composition measurement readings, but for the one composition being solved. The method includes calculating the difference between the predicted input stream composition and the composition measurement reading from a measuring device from the same input stream. The method includes selecting the measurement reading from a redundant measuring device for use as the measured variable when the absolute value of the difference is outside of a threshold.

According to one embodiment of the invention, a method of detecting inaccuracy in a measuring device of an input stream to a mixer having a plurality of input streams being mixed into an output stream is provided. The method includes obtaining composition measurement readings from input streams and an output stream around the mixer. The method includes obtaining the flow rates of input streams and the output stream. The method includes calculating a predicted input stream composition by solving a mass balance equation around the mixer using the flow rates of the composition measurement readings, but for the one composition being solved. The method includes calculating the difference between the predicted input stream composition and the composition measurement reading from a measuring device from the same input stream. The method includes determining if the measuring device is inaccurate when the absolute value of the difference is outside of a threshold.

According to one embodiment of the invention, a method of calibrating a first measuring device from a second measuring device on an input stream to a mixer having a plurality of input streams being mixed into an output stream, is provided. The method includes obtaining composition measurement readings from input streams and an output stream around the mixer. The method includes obtaining the flow rates of input streams and the output stream around the mixer. The method includes calculating a predicted input stream composition by solving a mass balance equation around the mixer using the flow rates and the composition measurement readings, but for the one composition being solved. The method includes calculating the difference between the predicted input stream's composition and the composition measurement reading from a measuring device from the same input stream, and assigning the measurement reading from the second measuring device to the first measuring device when the absolute value of the difference is outside of a threshold.

In all the above alternative embodiments, measurement readings can be taken from all input streams and output streams. In all the above embodiments, the flow rates of input and output streams can be determined from a controllable pump factor or by measuring. Alternatively, some input streams will have a known and substantially unvarying composition. Also, their flow rate can be substantially unvarying. These known factors can still be used in solving the mass balance equation. However, due to their unvarying composition and flow rate, the composition need not be measured nor their flow rate determined.

The methods and procedures disclosed herein enable automated calibration of each measuring device during the normal operation of the apparatus, when measuring the content of each stream processed according to the process of the invention.

### BRIEF DESCRIPTION OF THE DRAWINGS

The foregoing aspects and many of the attendant advantages of this invention will become more readily appreciated by reference to the following detailed description, when taken in conjunction with the accompanying drawings, wherein:

FIG. 1 is a schematic illustration of an apparatus for grinding, blending, and pumping two input streams of known composition, and mixing the streams to achieve an output stream of proportional characteristics according to the present invention.

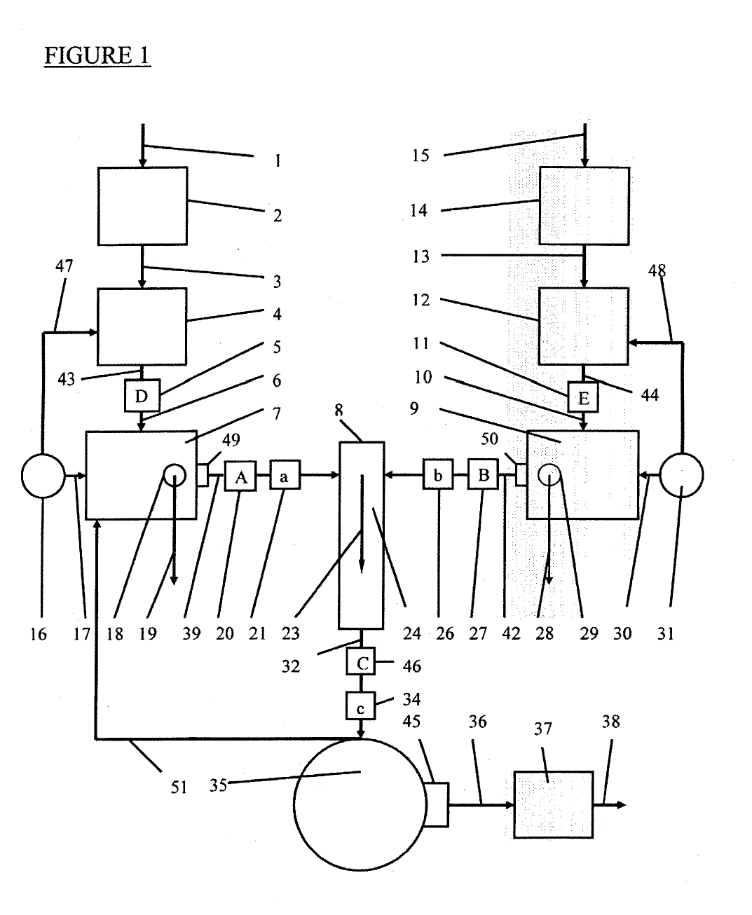

### DETAILED DESCRIPTION OF THE PREFERRED EMBODIMENT

Automated production of ground meat, having a specified amount of fat, lean, and water content in any desired ratio, is enabled by combining at least two input streams of ground meat, pumped through conduits by variable-speed pumps, and mixed together to provide one output stream having the controlled variable within a specified range. The output stream can be produced within a specified flow rate range. The pumps are capable of adjusting the mass flow of each input stream to achieve an output stream within a specified composition and flow rate range. The mass flow of each input stream is adjusted according to the measured fat, lean, and/or water content of each input stream so that, when the streams are combined into a single output stream, the resultant fat, lean, or water ratio in the combined output stream is controlled within the specified range. The pumps are monitored for flow rate in an effort to maintain the output stream within a specified flow rate range. Pumps can be constrained from exceeding the upper limit of the output stream's flow rate. Pumps can also be constrained from dropping the output stream's rate below the lower limit of the output stream's flow rate range. It is not entirely necessary to maintain the input streams at any specified constant ratio prior to mixing the streams together. The variable that is desired to be controlled in the output stream may be allowed to vary in the input streams because the measuring devices measuring the input stream's composition immediately downstream of the pumps will adjust the flow rate of each input stream in the correct proportions to produce a mixed output stream having a controlled amount of fat, lean, or water, in any desired range. Measuring devices are installed in each of the input streams and also in the combined output stream. Mass flow adjustment of each stream is controlled by a computer that processes data received from each measuring device, and then directs adjustment of each pump's speed independently, according to the measured content of each stream, so as to produce an output stream of specified ground meat. The processing of data from the measuring devices in the manner described herein is useful to control the input stream meat pumps or in detecting drift seen in some measuring devices or in selecting one from a pair of measuring devices. The method for automated ground meat production, according to the invention, has been found to be a significant improvement compared with other production methods; however the accuracy of the streams' content measurement reading is affected by a gradual divergence from a calibrated setting and recalibration may be required periodically. In one embodiment, the present invention provides a method for detecting when a measurement reading has drifted, and selecting an alternative reading. Drift when used in the context of measuring devices refers to deviation of measurement readings from the true reading, which may occur gradually.

Referring to the FIGURE, one embodiment of an apparatus is illustrated for the processing of goods, including boneless beef, or boneless meat of any kind, including pork, poultry, and any other protein containing fat, wherein the meat is derived from an animal source, and the fat, lean meat, and water content is unknown after harvesting from the animal's skeleton. The apparatus includes a series of pressure vessels that may be described as unsealed pressurized enclosures arranged to process two streams of meat. However, it should be appreciated that other embodiments may have more than two input streams. Some embodiments may have more than one output stream, and other embodiments may have one or more recycle streams. In other embodiments, additives can be provided to the input streams, including spices, particularly for sausages. “An unsealed pressurized enclosure” refers, in part, to the vessels' ability to process the beef in a continuous mode under positive pressure (at least from grinder to end of mixer). In one embodiment, the apparatus includes two input streams for processing beef from a grinder to a mixer to form a single output stream. The apparatus associated with each stream includes at least a grinder, a preblender (which mixes an input stream), a pump, and connecting conduits. Measuring devices may be located between grinder and preblender, and after the pump. The grinders, preblenders, pumps, and mixer can be provided by the Wenger Company. The apparatus is capable of grinding the separate streams of boneless meat, measuring the fat, lean, and water content of each stream, and adjusting the flow of each input stream according to a measured variable content of the respective streams. The two streams are combined together to form a single output stream, which is also measured to confirm the combined content of fat, lean, and water therein.

In one embodiment, two separate quantities of boneless meat with differing quantities of fat, lean, or water, are loaded into loaders 2 and 14 in the direction shown by arrows 1 and 15, respectively. Boneless meat, such as beef, may be chilled prior to loading, to a temperature in the range of 28° to 45° F., but most preferably to a temperature of 35° F.±1° F.

The second stream of boneless meat in the direction shown by arrow 10 is processed in much the same manner as is the first stream of boneless meat.

The first stream of boneless meat shown by arrow 1 is loaded into a variable-speed meat grinder 4 by loader 2 and conveyor 3, which may be fitted with a metal detector. Grinder 4 is driven most preferably by a variable-speed motor, which may be a hydraulic motor, and in such a manner that will enable a continuous flow of meat to be ground at a mass flow that can be varied as required to adjust to the demands of the system and, more particularly, the proportioned flow into continuous blender 8. For example, grinder 4 may have level-indicating devices that monitor the levels in the meat grinder vessel and the grinder can be sped up or slowed down to maintain the level within a suitable range. Grinder 4 is arranged to transfer ground meat along an enclosed conduit 43 through measuring device 5 and into preblender 7. Grinder 4 can be covered, apart from an open section to allow meat to drop into the hopper. The measuring device 5 can measure the fat, lean, and water content in the first stream of meat. Preblender vessel 7 receives product pumped therein, and blends the stream of ground meat while transferring said meat to the continuous mixer 8. The preblender vessel 7 is fitted with impellers mounted internally that are arranged to blend meat transferred therein and also to carry it toward the continuous mixer 8. The impellers mounted in preblender vessel 7 may be arranged with any suitable profile including paddles and Archimedes screw sections to enable efficient blending and removal of gas that may otherwise become entrapped within the meat stream as it is transferred into conduit 39 by pump 49. The meat pump 49 can be a positive displacement piston-type pump, vane pump, or screw pump that may be a matching twin screw or single screw, having a parallel or conical profile, to increase pressure. The preblender vessel 7 can also be provided with level indicators that will indicate the level of the meat in the vessel. If the level indicators indicate a high level, the grinder 12 may be slowed down or temporarily stopped. Alternatively, the pump 49 may be sped up to decrease the level in the preblender.

The type of pump 49 may be selected from any number of pumps and may comprise, for example, a pair of counter- or corotating, meshed, conical screws arranged to compress the stream of meat and diminish any gas voids contained within the meat stream. Such gas inclusions will most preferably comprise a large proportion of carbon dioxide, which can dissolve into the water and oils contained in the meat when suitably compressed. Preblender vessel 7 is also fitted with an exhaust duct 18 so as to allow extraction of gases 19, such as carbon dioxide, that can be injected into vessel 7 through bottom injectors, which can also enable the adjustment of the temperature of the meat blended therein. Gas supply source 16 will supply liquid CO₂ to vessels 7 and 4. CO₂ liquid will vaporize immediately after release by control valves, which can be used to control the temperature. Exhaust duct 18 for vessel 7 can be fitted with an extractor fan or may have a butterfly valve to maintain or control a selected pressure in the vessel. Exhaust duct 18 will thusly carry any vaporized amount of water and can be used to control the water content in the meat stream.

From pump 49, meat is transferred through conduit 39 with measuring devices 20 and 21 conveniently mounted therein, and into the continuous blender 8. Continuous blender 8 is a mixer to mix the input streams.

The second stream of boneless meat shown by arrow 15 is loaded into a variable-speed meat grinder 12 by loader 14 and conveyor 13, which may be fitted with a metal detector. Grinder 12 is driven most preferably by a variable-speed motor that may be a hydraulic motor and in such a manner that will enable a continuous flow of meat to be ground at a mass flow that can be varied as required to adjust to the demands of the system and, more particularly, the proportioned flow into continuous blender 8. For example, grinder 12 may have level-indicating devices that monitor the levels in the meat grinder vessel and the grinder can be sped up or slowed down to maintain the level within a suitable range. Grinder 12 is arranged to transfer ground meat along enclosed conduit 44 through measuring device 11 and into preblender 9. Grinder 12 can be covered, apart from an open section to allow meat to drop into the hopper. The measuring device 11 can measure the fat, lean, and water content in the second stream of meat. Preblender vessel 9 receives product pumped therein, and blends the stream of ground meat while transferring said meat to the continuous mixer 8. The preblender vessel 9 is fitted with impellers mounted internally that are arranged to blend meat transferred therein and also carry it toward the continuous mixer 8. The impellers mounted in preblender vessel 9 may be arranged with any suitable profile including paddles and Archimedes screw sections to enable efficient blending and removal of gas that may otherwise become enclosed within the meat stream as it is transferred into conduit 42 by pump 50. The meat pump 50 can be a positive displacement piston-type pump, vane pump, or screw pump, which may be a matching twin screw or single screw having a parallel or conical profile to increase pressure. The preblender vessel 9 can also be provided with level indicators that will indicate the level of the meat in the vessel. If the level indicators indicate a high level, the grinder 12 may be slowed down or temporarily stopped. Alternatively, the pump 50 may be sped up to decrease the level in the preblender.

The type of pump 50 may be selected from any number of pumps and may comprise, for example, a pair of counter- or corotating, meshed, conical screws arranged to compress the stream of meat and diminish any gas voids contained within the meat stream. Such gas inclusions will most preferably comprise a large proportion of carbon dioxide that can dissolve into the water and oils contained in the meat when suitably compressed. Preblender vessel 9 is also fitted with an exhaust duct 29 so as to allow extraction of gases 28, such as carbon dioxide, that can be injected into vessel 9 through bottom injectors, which can also enable the adjustment of the temperature of the meat blended therein. Gas supply source 31 will supply liquid CO₂ to vessels 9 and 12. CO₂ liquid will vaporize immediately after opening of control valves to control the temperature. Exhaust duct 19 for vessel 9 can be fitted with an extractor fan or may have a butterfly valve to maintain or control the pressure in the vessel. Exhaust duct 29 will thusly carry any vaporized amount of water and can be used to control the water content in the meat stream. Gas supplies 16 and 31 are fed to grinders 4 and 12 and preblenders 7 and 9 to displace air and oxygen.

From pump 50, meat is transferred through conduit 39 with measuring devices 26 and 27 conveniently mounted therein, and into the continuous blender 8. Continuous blender 8 is a mixer to mix the input streams. Continuous blender 8 is preferably controlled within a specified flow rate range. Accordingly, the control of pumps 49 and 50 may be arranged to cooperatively produce a combined flow rate that will neither exceed the upper limit of the range nor drop the flow rate below the lower limit of the range. For example, one pump can be selected as the master of the combined flow controller; however, if the pump were to reach its operating limit, the slave or second pump may be engaged in combined flow control mode. Pumps will typically operate in composition control mode, but flow will be monitored and controlled as well. Operation of the pumps may result in constraining the pump speed not to increase or decrease if it would result in the combined output stream's being outside the combined output composition range. Back pressure in conduits 39 and 42 is created by controlling the flow of combined streams through the continuous blender 8.

Each stream of boneless beef that has been ground is preferably fed into preblenders 7 and 9. Blending each stream in isolation, prior to combining with another stream, can provide a substantially homogenous stream of meat that can decrease the variation in measurements taken by measuring devices 20, 21, 26, and 27, respectively. The pressure in preblenders 7 and 9 can be elevated by controlled restriction of the exhaust, which will prevent ingress of atmospheric oxygen.

The first and second processed input streams of meat can be transferred and combined in the continuous blender 8 described in one or more of the above-referenced applications.

The equipment is arranged to automatically measure at least one component of each stream of meat coming into the continuous blender. The measured component may be fat, lean, and water or any other component or characteristic of the meat. The measurements are made as the streams are transferred through measuring devices 20, 21, 26, and 27, installed after pumps 49 and 50, measuring devices 5 and 11 installed after grinders 4 and 12, and measuring devices 46 and 34 installed after continuous mixer 8 as shown in the FIGURE. The measuring devices, known as GMS, and/or AVS, are described in detail in the above-referenced patent applications. The measuring devices, which are preferably of the GMS type, are integrated into the conduits to enable automatic measuring of the meat properties, which may include but are not limited to, weight, water content, fat content, and lean content, thereby enabling the automatic adjustment of the pumps 49 and 50.

Additionally, all vessels, equipment, and connecting conduits can be filled with selected gases as required. The gas may comprise at least carbon dioxide or nitrogen. But in any event, the gas should have reduced amounts of oxygen in proportions lower than normal air. The continuous blender 8 is driven by a variable-speed motor, thereby combining first and second streams into a single stream that is transferred through blender 8 and mixed therein by screws 24 enclosed therein. The combined and blended stream of meat can be transferred through conduit 32 and through measuring devices 46 and 34. Conduit 32 is connected to hopper 35 with an optional positive displacement pump 45 at one outlet. It should be noted that the continuous blender 8 has adequate capacity to pump the combined streams and a fine grinder could be mounted directly to the exit end of continuous blender 8 if so desired. Pump 45, optionally can be provided with a grinder to finely grind meat. Hopper 35 can be arranged with a conical profiled side elevation and can be fitted with a mixer mounted therein. The variable-speed, positive-displacement pump 45 is connected directly to the base of the conical profiled hopper 35 so as to enable a controlled pumping of the stream of meat into conduit 36. Conduit 36 may be arranged with an outer jacket in a manner to allow heated water to pass therethrough, enabling the heating of the conduit 36. Such heating can minimize the buildup of fat on the internal walls of the conduit 36, which may otherwise accumulate excessively.

In one embodiment, conduit 36 is connected to a chub packaging apparatus 37 with a chub clipping and transfer section. Filled, clipped, and sealed, substantially oxygen-free chubs, which may also be evacuated, are then transferred onto conveyor 38. Conveyor 38 is arranged to transfer finished chub packages into a refrigerated storage room and labeling station, and/or further packaged into cartons that can then be loaded onto pallets in readiness for shipping. Chub packages can be labeled or marked with an identification mark that is associated with all types of information that can be retrieved via a computer or as described in the above-referenced applications.

Continuous blender 8 may be provided with an enclosed screw-style transfer and blender driven by a variable-speed driver. Alternative mixing devices can be integrated into the automated ground meat production system, as herein described. For example, grinders 4 and 12 may be used to blend the combined first and second streams of meat.

Measuring devices 5, 11, 20, 21, 26, 27, 46, and 34, as shown in the FIGURE, may be used to measure the fat, water, and/or lean content of meat streams transferred therethrough. However, when GMS measuring devices are installed in close proximity to each other, the operation of each device, when taking a measurement reading, should be staggered so that only a single device is actively measuring at any one time. The GMS devices utilize microwave (radiofrequency) and interference can occur between the devices when operated at the same time. Staggering the operation of the devices may avoid interference. The GMS devices are capable of actively measuring at a rate of approximately 1-2 times per second. For example, device 5 may be activated to read a first measurement followed in sequence by device 20, then 21, 11, 27, 26, 46, and 34. Following the completion of such a sequence of measurements, the sequence can be repeated for any number of cycles. However, it should be appreciated that the order of measurements may be altered in any manner. In one embodiment, every measurement reading from one device is added and divided by the number of readings taken from the device to arrive at an average reading. Other embodiments may obtain the median reading of all the measurement readings. Both the average and median readings are representative readings from a sampling of the readings taken from one measuring device. It is also possible to have more than one measuring device at one stream, i.e., pairs of measuring devices or redundant measuring devices. The readings from one or from all measuring devices on one stream can be used to obtain an average measurement or a median measurement. The representative reading obtained from a plurality of readings is used in computations to control the apparatus, as further described below. Additionally, it should be noted that the measurements are taken while each stream of meat is in motion. The average quantity of meat measured can vary according to the mass flow of each stream. Therefore, it is preferable to vary the sequence of measurements for every cycle and, preferably, a random order can be performed from a virtually infinite combination of sequences.

During each sequence or series of measurements, the data from each measuring device is recorded in isolation from other device measurements. In this way, a progressive history of measurements can be recorded in a computer. The computer can include a database structure stored in memory. The memory can comprise a RAM component and also a storage hard drive component. In this way, any number of selected measurements from any particular measuring device can be accumulated and a representative measurement is calculated for each measuring device. The representative measurement can be an average or median, or any other measure derived from a sampling of readings that is representative. In one embodiment, for example, the sum of three consecutive measurements from any one measuring device can be selected and averaged to yield the average of the three consecutive measurements. In other embodiments, the measurements of pairs of measuring devices are added and divided by the number of measurements taken from both instruments. The representative measurement, from the subject measuring device or devices, having measured one particular stream of meat, can then be used in the computations for the adjustment of the pump associated with the stream with improved accuracy. Similarly, selected consecutive measurements from any and all measuring devices can be stored, and processed to provide representative measurements that can then be used to adjust the flow of the associated stream with pumps. Furthermore, the sum of any number of consecutive measurements can be averaged, over time, to provide such measurements for mass flow control of each stream. Alternating measurements from two or more measuring devices according to any pattern, random or otherwise, can be accumulated and averaged to achieve an improved performance of the automated apparatus for ground meat production. Any trends that may be caused by measuring device malfunction or meat variations can be identified and adjusted as needed without the intervention of an apparatus operator, according to the invention. Examples of recorded measurement data manipulation, for the purpose of improving ground meat production efficiency, can involve programming of the computer to perform numerous simultaneous calculations so as to optimize use of the recorded measurement data that, for example, can include the continuous calibration or adjustment of the measuring devices.

In practice, accumulating data from several consecutive measurements, followed by an averaging of the accumulated measurements is a preferred method to achieve an improved homogenized blend of ground meat. The data can also be used to check and then calibrate or adjust the paired devices, determine when a device has drifted, select an alternate device, and control the mass flow of the pumps based on the correctly functioning device. In the FIGURE, a preferred embodiment shows a total of eight measuring devices integrated into a production apparatus wherein two input streams of ground meat are transferred to a mixer and combined into a single output stream. For the purposes of facilitating an explanation of the operation of the apparatus, each measuring device can be assigned a letter. Each input and output stream will also have a flow rate associated with it. The input streams are combined to produce the output stream that is discharged from the mixer 8. In the first stream, a measuring device is located in conduit 43. Conduit 43 is connected directly to the pre-blender 7 with the measuring device D located therein. Thereafter, the first stream is transferred through conduit 39 with consecutively positioned measuring devices A and a. The first stream terminates when it is combined with the second stream in the mixer 8. The second stream 15 is transferred via conduit 44, through measuring device E, into preblender 9 and then through conduit 42 with measuring devices B and b located therein. After transferring input streams 1 and 15 to mixer 8, the combined output stream is measured again by devices C and c. By conservation of mass, the mass of input streams will equal the mass of the output stream, allowing the input streams to arrive at the output stream. Assuming all measuring devices are operating accurately and reading the mass fraction of one component, the measurements of one component passing through devices A and B should be equal to C allowing for sufficient time for the mass leaving devices A and B to arrive at location C. Therefore, this simple mass balance calculation can be used to check the accuracy and drift of the measuring devices. Assuming that measuring devices measure a mass fraction of a component, the need to obtain the mass flow rates arises. Flow rates can be measured by instrument or assumed from the pump speed. In some embodiments, pumps may pump a certain volumetric flow rate for every rotation of the pump impeller taking into account only slippage. This correlation can many times be provided by the pump vendor, or can be determined through simple experimentation. The speed, as measured by revolutions per minute, or any other factor that is directly controllable can be correlated to a volumetric or mass flow rate by including density, passing through the pump. Additionally, the accuracy of a measurement recorded by device A can be checked after allowing time for transfer of the measured stream section to device C by subtracting the value of a measurement made by device B. Equations can be solved for every device A, a, B, b, C, c, D, and E. Patterns and trends can be recognized when measurements are noticed to be drifting when all other measurements are remaining steady, or nearly so. A sequence of measurements followed by a series of calculations can be performed by a computer processor to check the accuracy of each measuring device by solving mass balance equations using the measurement readings and the flow rates for every one of the input streams and the output stream except for the quantity that is being solved. The solution to a mass balance equation is the predicted value of what the measurement reading from the measuring device should be. If the absolute value of the difference between the predicted measurement and the actual or representative measurement from the measuring device is greater than a predetermined limit, the measuring device can be determined to be inaccurate. This is, of course, after verifying that all other measuring devices are reading within acceptable limits. If there is more than one measuring device on any one stream, the measuring device that has drifted can be calibrated by assigning the value of the accurate measuring device to the inaccurate measuring device. In this manner, the measuring device that has drifted or become inaccurate can be recalibrated. In other embodiments, the measuring device determined to have drifted will be put out of service, and its redundant pair, or alternate, will be used in controlling the pump. In other embodiments, the measuring device with the least amount of error will be the one selected from which to control the pump. It will also be appreciated that it is not necessary to incorporate the number of devices as is shown in the FIGURE to achieve the accuracy needed during normal operation of the apparatus. However if each pair of devices is reduced to a single measuring device, the malfunction of any single device would most probably require the apparatus to be shut down to enable replacement of the malfunctioning device. Such a shutdown and device replacement can be delayed to a convenient time when redundant devices or pairs are installed in adjacent locations.

Referring again to the devices shown as A, a, B, b, C, and c, other calculations can be programmed into the computer processor. For example, in addition to the calculation of A+B=C, the following equations can be used to check accuracy and performance of any individual device, wherein any letter represents a mass quantity, calculated by multiplying mass fraction with mass flow or by any other determination.

C−A=B

C−B=A

a+b=c

[(A+a)+(B 30 b)]/2=C

C−(A+a)/2=(B+b)/2

A=a

B=b

C=c

(C+c)/2=A+B

a₁=c₁−b₁; b₁=c₁−a₁; c₁=a₁+b₁

a₂=c₂−b₂; b₂=c₂−a₂; c₂=a₂+b₂

a₃=c₃−b₃; b₃=c₃−a₃; c₃=a₃+b₃

In the event that any particular device is found to malfunction, it can be recalibrated, meaning that, if a measuring device is determined to be reading inaccurately, the signal by the malfunctioning device is set to equal the measurement of the properly functioning device. Alternatively, the malfunctioning device can be excluded from subsequent calculations until it can be replaced or repaired and the functioning device can be selected to take its place.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. A method of controlling the rate of a pump for an input stream to a mixer having a plurality of input streams being mixed into an output stream, comprising:
obtaining a plurality of composition measurements of an input meat stream being transferred by a pump;
calculating a representative measurement based on the plurality of measurements;
determining the flow rate capacity of the pump based on a controllable pump factor; and
calculating the controllable pump factor to give an input flow rate to provide a meat output stream within a composition range and flow rate range, said meat output comprised from at least two input meat streams of differing compositions, wherein the input meat flow rate is the solution of a mass balance equation around the mixer using the representative measurement to solve for the input meat flow rate.

2. The method of claim 1, wherein the input stream flow rate is constrained not to decrease below a point that will result in the output stream's flow rate or composition being outside the ranges.

3. The method of claim 2, wherein a second pump is controlled to decrease the flow rate of a second input stream if the first stream's pump is at a limit where increasing or decreasing the flow rate of the first stream will cause the output stream to be outside the ranges.

4. The method of claim 1, wherein the input stream flow rate is constrained not to increase above a rate that will result in the output stream's flow rate or composition being outside the ranges.

5. A method of selecting one reading from a pair of measurement readings to use as a measured variable in the control of an input stream to a mixer having a plurality of input streams being mixed into an output stream, comprising:
obtaining composition measurement readings from input streams and an output stream around the mixer;
obtaining the flow rates of input streams and the output stream around the mixer;
calculating a predicted input stream composition by solving a mass balance equation around the mixer using the flow rates and composition measurement readings but for the one composition being solved;
calculating the difference between the predicted input stream composition and the composition measurement reading from a measuring device from the same input stream; and
selecting the paired measurement reading for use as the measured variable when the absolute value of the difference is outside a threshold.

6. A method of detecting inaccuracy in a measuring device of an input stream to a mixer having a plurality of input streams being mixed into an output stream, comprising:
obtaining composition measurement readings from input streams and an output stream around the mixer;
obtaining the flow rates of input streams and the output stream;
calculating a predicted input stream composition by solving a mass balance equation around the mixer using the flow rates and composition measurement readings but for the one composition being solved;
calculating the difference between the predicted input stream composition and the composition measurement reading from a measuring device from the same input stream; and
determining the measuring device is inaccurate when the absolute value of the difference is outside a threshold.

7. A method of calibrating a first measuring device from a second measuring device on an input stream to a mixer having a plurality of input streams being mixed into an output stream, comprising:
obtaining composition measurement readings from input streams and an output stream around the mixer;
obtaining the flow rates of input streams and the output stream around the mixer;
calculating a predicted input stream composition by solving a mass balance equation around the mixer using the flow rates and the composition measurement readings but for the one composition being solved; and
calculating the difference between the predicted input stream composition and the composition measurement reading from a measuring device from the same input stream; and
assigning the measurement reading from the second to the first measuring device when the absolute value of the difference is outside a threshold.
